(19) United States
(12) Patent Application Publication
(10) Pub. No.: US 2025/0214469 A1
(43) Pub. Date: Jul. 3, 2025

(54) METHOD FOR POSITIONING A VEHICLE

(71) Applicant: MAHLE International GmbH, Stuttgart (DE)

(72) Inventor: Mike Boettigheimer, Kornwestheim (DE)

(21) Appl. No.: 18/852,459

(22) PCT Filed: Mar. 24, 2023
(86) PCT No.: PCT/EP2023/057734

§ 371 Date: Sep. 28, 2024

(30) Foreign Application Priority Data
Mar. 30, 2022 (DE) 102022107569.9

(51) Int. Cl. B60L 53/36; B60L 53/12; B60L 53/38; H01F 38/14; H02J 50/10; H02J 50/12; H02J 50/90

(52) U.S. Cl. CPC B60L 53/36; B60L 53/12; B60L 53/38; H02J 50/10; H02J 50/12; H02J 50/90; H01F 38/14

(57) ABSTRACT

A method for positioning a vehicle with a mobile inductive charging device in a defined position relative to a stationary inductive charging device may include generating a first and second voltage signal in a first and second sensor winding, respectively, via a positioning signal, detecting the first and second voltage signals in a signal detection unit, converting the first and second voltage signal into a first and second digital signal, respectively, via an evaluation unit, and processing and comparing the first and second digital signals via the evaluation unit. Processing the digital signals may include transforming the digital signals into a frequency domain. The method may further include calculating, from the comparison of the first digital signal and the second digital signal, a directional deviation value between the longitudinal direction of the vehicle and a connecting line extending between the stationary inductive charging device and the mobile inductive charging device.

### CROSS-REFERENCE TO RELATED APPLICATIONS

This application claims priority to International Patent Application No. PCT/EP2023/057734, filed on Mar. 24, 2023, and German Patent Application No. DE 10 2022 107 569.9, filed on Mar. 30, 2022, the contents of both of which are hereby incorporated in their entirety.

### TECHNICAL FIELD

The invention relates to a method for positioning a vehicle according to the preamble of the independent claim.

### BACKGROUND

DE 102014202747 A1 shows a device and a method for detecting a positional deviation of a passive coil with respect to a primary coil of an inductive charging system for a vehicle. Here, two windings of a double winding system are provided for determining the positional deviation and the two windings are arranged symmetrically, each arranged offset by 45° in one direction relative to the center axis of the vehicle and arranged offset by 90° from one another. A voltage is induced in each of the two windings of the double winding system by the magnetic field of the primary coil. The positional deviation is determined by a simple comparison of the two induced voltages. However, the simple comparison of the two voltages in the time domain makes it difficult to achieve a high level of accuracy and range in terms of practical implementation.

US 2016380488 A1 shows a method for determining a relative position of a wireless power transmitter with respect to a wireless power receiver. Here, the relative position is determined by using a 3-axis signal generator and a 3-axis sensor. Therefore, a simple direct comparison of the intensities of the voltages is not possible, as is the case in the double winding system from DE 102014202747 A1. During signal processing, a Fourier transform, in particular a fast Fourier transform, is also used in US 2016380488 A1.

### SUMMARY

The present invention is concerned with the object of providing improved or at least alternative embodiments for an inductive charging device of the type mentioned at the outset.

The present invention proposes a method for positioning a vehicle with a mobile inductive charging device in a defined position relative to a stationary inductive charging device. The mobile inductive charging device or the stationary inductive charging device has a first sensor winding with a first radial longitudinal direction and a second sensor winding with a second radial longitudinal direction. The first radial longitudinal direction and the second radial longitudinal direction are arranged at an angle between 70° and 110° in relation to one another, preferably perpendicular in relation to one another and at an angle between 35° and 55° in relation to the longitudinal direction of the vehicle or in relation to the target vehicle longitudinal direction, preferably at a 45° angle in relation to the longitudinal direction of the vehicle or in relation to the target vehicle longitudinal direction.

Here, a positioning signal, preferably a positioning signal generated in the stationary inductive charging device or in the mobile inductive charging device, generates a first voltage signal in a first sensor winding and a second voltage signal in a second sensor winding. The first sensor winding has a first radial longitudinal direction and the second sensor winding has a second radial longitudinal direction. The at least one first voltage signal is detected in a signal detection unit and the at least one second voltage signal is detected in a signal detection unit and converted into a second digital signal. An evaluation unit converts the first voltage signal into a first digital signal and the second voltage signal into a second digital signal and processes and compares the first digital signal and the second digital signal. The processing of the first digital signal and the second digital signal involves a transformation into the frequency range. A directional deviation value between the longitudinal direction of the vehicle and the connecting line between the stationary inductive charging device and the mobile inductive charging device is calculated from the comparison of the first digital signal with the second digital signal.

Compared to the state of the art, this offers the advantage that a simple comparison of the signals in the frequency range is possible. In contrast, DE 102014202747 A1 only shows a solution for a hardware-side structure, but no corresponding signal processing, while US 2016380488 A1 requires a much more complex signal processing.

A vehicle charging system for inductive charging comprises at least a first, usually stationary, inductive charging device and a second, usually mobile, inductive charging device.

The term “inductive charging device” here therefore refers to only one of at least two parts that are necessary for an inductive charging process for energy transmission. In the induction charging process, an energy transmission winding generates a magnetic alternating field during the energy transmission in an inductive charging device. This alternating magnetic field induces a voltage in another energy transmission winding of another inductive charging device. This additional inductive charging device thus serves as a counterpart for this specific charging process. The energy is transmitted wirelessly and absorbed by inducing a voltage.

A stationary inductive charging device is the non-mobile part of a vehicle charging system, i.e. the part that does not move with the vehicle.

A stationary inductive charging device can preferably be located on, at or in a floor. Here, this can be an inductive charging device mounted on the ground or an inductive charging device sunk into a ground or floor. A floor can be a roadway, a parking lot surface, a garage floor, a floor in a parking garage or another building. Alternatively, a stationary inductive charging device can also be located on walls or the like.

It is also possible that it is a stationary inductive charging device for a dynamic inductive charging process. In a dynamic inductive charging process, an energy storage of a vehicle can be charged while it is moving. For example, in this case the stationary inductive charging device can extend along the roadway under, in or on the road surface.

A mobile inductive charging device can be arranged on and/or in a vehicle. In general, this refers to the part of a vehicle charging system that moves with the vehicle. An inductive charging device on and/or in the vehicle is therefore suitable for picking up the magnetic field and making electrical energy available from an energy storage in the vehicle, for example a battery or an accumulator in the vehicle.

In principle, a vehicle charging system can also be used for bidirectional charging. Here, the vehicle can also temporarily feed energy from the energy storage into the power grid via the vehicle charging system.

In principle, an inductive charging device according to the invention can be used for any type of land, water or air vehicle that has an electric or hybrid drive. In particular, passenger cars, buses and trucks may be mentioned here.

For efficient energy transmission, the mobile inductive charging device must be positioned as precisely as possible in relation to the stationary inductive charging device. The mobile inductive charging device must therefore be positioned in a defined position in relation to a stationary inductive charging device. The defined position is a predetermined position which preferably takes into account that energy transmission can take place with the highest possible efficiency. In particular, here it can be taken into account that one energy transmission winding in each of the two inductive charging devices is positioned as close as possible in relation to one another and opposite one another with regard to an air gap between them. Since both energy transmission windings generally do not have to be the same size, a symmetrical positioning in which the winding axes of the two energy transmission windings lie as close to one another as possible is also advantageous. Exact positioning is often difficult or impossible for the driver without additional support in the form of a driver assistance system.

The positioning method according to the invention can be a fully automatic positioning method in which the vehicle parks completely autonomously above the stationary inductive charging device. However, it is also possible that the positioning uses a driver assistance system to show the driver how to steer the vehicle in order to position it optimally in relation to the stationary inductive charging device.

A positioning signal is an electromagnetic or magnetic alternating field, which can induce a voltage signal in a sensor winding. Preferably, here the positioning signal is emitted or generated by the stationary inductive charging device to which the vehicle is to be positioned. It is possible that the positioning signal here is emitted or generated directly by an energy transmission winding of an inductive charging device, or that one or more additional windings or another signal generating device is present for this purpose.

The positioning signal preferably transmits power that is significantly lower than the power transmitted during energy transmission.

The connecting line between the stationary inductive charging device and the mobile inductive charging device takes into account, in particular the desired defined position of the two inductive charging devices in relation to one another, as explained above. In particular, the connecting line can run between the two centers of two energy transmission windings in the inductive charging devices.

The first and/or the second sensor winding can be arranged in or near the mobile or stationary inductive charging device.

In general, a coil is defined here as a component for generating or receiving a magnetic field. A coil can consist of a winding and optionally further elements such as a magnetic core and a coil carrier. Here, a winding is a wound arrangement of a current conductor. A winding can consist of one or more turns, with one turn representing one complete circuit of a conductor. In general, however, a winding can also consist of less than one turn, for example 0.5 turns. Of course, an incomplete number of turns, such as 2.5 turns, is also possible.

A sensor winding according to the invention can be designed in different forms and here can have half a turn, one turn or preferably a plurality of turns. Here, a conductor of such a sensor winding can, for example, have a cross-sectional area of between 0.01 mm² and 2 mm². A conductor can be designed here as a stranded wire, as a single conductor or in another form, for example in the form of conductor tracks on printed circuit boards.

In general, a winding extends in at least two dimensions around a winding axis. The winding axis is the axis around which the winding is wound. The main extension direction perpendicular to the winding axis is referred to here as the radial longitudinal direction. In a winding with a rectangular, non-square cross-section, the radial longitudinal direction runs along or parallel to the longer side of the rectangle. In a winding with an elliptical cross section, the radial longitudinal direction runs along or parallel to the main axis of the ellipse. The radial longitudinal direction of a sensor winding according to the invention can lie in a plane that extends parallel to the ground.

An arrangement of the angles of the radial longitudinal directions such that the two radial longitudinal directions intersect at an angle between 70° and 110°, preferably perpendicularly, and that the respective radial longitudinal direction is arranged at an angle of 35°-55°, preferably 45°, to the longitudinal direction of the vehicle or to the target vehicle longitudinal direction, is advantageous for the highest possible sensitivity in detection and the simplest possible calculation of the positional deviation between the vehicle and the stationary inductive charging device.

If the two angles between the respective radial longitudinal direction of the sensor windings and the longitudinal direction of the vehicle or the target vehicle longitudinal direction are approximately equal, this means that the sensor windings are arranged symmetrically to the direction of travel.

This is particularly advantageous, as the symmetrical arrangement of the sensor windings in relation to the direction of travel means that with equally large positional deviations to the right or left, the corresponding ratios of the voltages induced in the sensor windings are also symmetrical and thus a relatively simple calculation of the positional deviations from the induced voltages is possible.

If the two angles are 45°, the two sensor windings are at a 90° angle in relation to one another, which is ideal for optimal evaluation of the sensor signals.

A magnetic alternating field can induce an alternating voltage in a sensor winding, which in turn can cause a current to flow in the conductor from which the respective sensor winding is formed. The alternating voltage induced in the first sensor winding is referred to here as the first voltage signal, and the alternating voltage induced in the second sensor winding is referred to as the second voltage signal.

In a signal detection unit, the positioning signal is picked up, for example, by the inductive charging device and provided in such a way that it can be sampled in an analog-to-digital conversion unit. The signal detection unit here includes circuits, wherein at least one circuit includes the first sensor winding and another circuit includes the second sensor winding. The circuits can contain additional components and are designed such that the voltage signals can be further processed with as little effort as possible.

The first voltage signal and/or the second voltage signal can be converted into a digital signal, for example in an analog-to-digital conversion unit. Here, the analog signal is preferably sampled at a specific sampling frequency. The analog-digital conversion unit can be part of an evaluation unit. For conversion to a digital signal, the analog-to-digital conversion unit does not necessarily have to directly sample the voltage dropping across the first sensor winding or the voltage dropping across the second sensor winding. Here, a voltage dropping across one or more further components in the same circuit as the first sensor winding or as the second sensor winding can also be sampled.

An evaluation unit can contain further elements for evaluating the digital signal. These can preferably be implemented as logical blocks in a computing unit. A computing unit can be implemented on one or more local electronic devices, which are implemented, for example, in the form of microprocessors or local control units, and/or the computing unit can be part of a larger control unit or a central computing unit in the vehicle. Here, different logical blocks can be implemented on the same or different microprocessors or control units.

In a frequency transformation, a signal from the time domain is mathematically transformed into the frequency domain. For a time-dependent signal, an evaluation in the frequency domain provides information on how strongly a certain frequency or a certain frequency domain is present in this signal.

An evaluation in the frequency domain is advantageous here, in particular since it is possible to filter the frequency or frequency domain of the positioning signal and thus achieve a better signal-to-noise ratio and thus a greater range.

From the two digital signals in the frequency domain, a value each can now preferably be determined. Preferably, this value indicates how much voltage was induced in the respective sensor winding, in particular how much voltage was induced in the respective sensor winding at the excitation frequency of the positioning signal.

When comparing the two correspondingly processed signals, a directional deviation value between −1 and 1 can be determined, for example, by subtracting the two values and normalizing to the larger of the two values.

The ratio of the two values derived from the correspondingly processed signals enables statements to be made about the angle by which the longitudinal direction of the vehicle deviates from the direction of the vehicle towards the stationary inductive charging device. In this respect, the present sensor arrangement can also be referred to as a rotation angle sensor. It is determined, at least in a certain angular range, by which angle the connecting line between the stationary inductive charging device and the mobile inductive charging device is rotated relative to the longitudinal direction of the vehicle. Preferably, the directional deviation value is proportional to the angle between the longitudinal direction of the vehicle and the connecting line between the stationary inductive charging device and the mobile inductive charging device.

The longitudinal direction of the vehicle is the direction in which the vehicle moves when it is traveling straight ahead, i.e. not on a curve. In most cases, this is also the main direction of travel of the vehicle.

A stationary inductive charging device has a target vehicle longitudinal direction. This is the direction in which the longitudinal direction of the vehicle should be after a successful positioning process.

Preferably, the positioning signal is generated in the stationary inductive charging device or in the mobile inductive charging device.

Here, the positioning signal is always generated in the inductive charging device, which does not contain the sensor windings. If the positioning signal is generated in the stationary inductive charging device, the mobile inductive charging device contains the sensor windings. If the positioning signal is generated in the mobile inductive charging device, the stationary inductive charging device contains the sensor windings.

The positioning signal can, for example, be generated by a coil or winding that produces a magnetic alternating field. Here, this can be an energy transmission winding that is present for energy transmission in the mobile inductive charging device or in the stationary inductive charging device. Alternatively, the positioning signal can also be generated by another winding or coil.

Preferably, the transformation into the frequency domain is realized by a discrete Fourier transform, in particular by a fast Fourier transform (FFT). A discrete Fourier transform, or DFT for short, transforms a signal sampled in the time domain into a discrete frequency signal using a Fourier transform. Here, the voltage signal induced in the sensor windings is sampled discretely. What is relevant here is the sampling frequency, which determines which frequencies can be resolved. The sampling frequency must be selected so that the relevant frequencies, especially the excitation frequency, can be resolved. A special, optimized form of the discrete Fourier transform is the fast Fourier transform (FFT). Since the optimized algorithm minimizes complexity and thus computational effort, the FFT is the most commonly implemented form of discrete Fourier transforms.

It is advantageous if the signal transformed into the frequency domain is filtered by a filter with a bandwidth B around the excitation frequency. The positioning signal generated by the stationary inductive charging device is generated with a specific excitation frequency. The excitation frequency can be in the range of 10 kHz to 150 kHz. Preferably, the excitation frequency is in the range of 120 kHz to 145 kHz. Particularly preferably, the excitation frequency is in the range between 120 kHz and 125 kHz or in the range between 130 kHz and 145 kHz. For example, the excitation frequency can be 140 kHz. It is therefore not necessary to evaluate the complete induced voltage signal in the entire frequency range, but an evaluation close to the excitation frequency is sufficient. A digital filter can be used for this purpose.

A digital filter is a mathematical function applied to the discrete signal in the frequency domain. The discrete frequency values are thus limited to values in a specific preset frequency band with bandwidth B. The bandwidth can be in the order of 1 kHz, for example. The frequency band is selected such that it contains the excitation frequency, advantageously such that it contains the excitation frequency in the middle.

Preferably, an averaged directional deviation value is determined by forming an average, in particular a moving average, from a plurality of directional deviation values, in particular from 10 directional deviation values determined at discrete, successive points in time.

Without appropriate averaging, there will be large fluctuations in the directional deviation values, in particular when there are large distances between the vehicle and the stationary inductive charging device. The main reason for this is the increasing noise of the induced voltage signals. In particular, when the present method is used as a driver assistance system and the directional deviation value is displayed graphically, the range up to which the driver is able to park using the displayed directional deviation value is limited by the fluctuations that increase with distance. When calculating a moving average, the average of the last N values is always calculated. This means that a new average is not calculated block by block every T values, but if a new value is added, the last value of the previously considered values is dropped and a new mean value is calculated directly. Instead of a block-by-block approach, this calculation is moving.

In a preferred embodiment, the first voltage signal, which is converted into a first digital signal in the evaluation unit, is directly the voltage dropping across the first sensor winding and the second voltage signal, which is converted into a second digital signal in the evaluation unit, is directly the voltage dropping across the second sensor winding.

Here, the induced voltage is measured by directly measuring the induced voltage on the first sensor winding and on the second sensor winding. This is a very simple way of signal acquisition.

In an alternative preferred embodiment, the signal detection unit has a first oscillating circuit comprising at least the first sensor winding and a first capacitance and a second resonant circuit comprising at least the second sensor winding and a second capacitance.

An oscillating circuit contains at least one inductance, for example in the form of a winding or coil, here preferably a sensor winding, and a capacitance and has a resonance frequency which is dependent on the size of the capacitance and inductance. In the present case, it is advantageous if the resonance frequency of the first oscillating circuit and the second oscillating circuit is approximately equal to the frequency of the positioning signal, i.e. if the oscillating circuits are tuned to the excitation frequency of the positioning signal. Thus, the respective oscillating circuit is resonantly excited by the positioning signal. This allows the signal amplitude to be amplified.

The measurement of the voltages induced in the oscillating circuits can, for example, be carried out via a voltage measurement in an analog-digital conversion unit which can be integrated directly into the oscillating circuit.

In one variant, the first oscillating circuit may have a first damping resistor and the second oscillating circuit may have a second damping resistor. The function of the damping resistors is, for example, to protect the sensor windings, components of the analog-digital conversion unit or other components from being destroyed by excessively high voltages or currents that can occur in the event of resonance. The damping resistors thus reduce the quality of the oscillating circuits.

In a preferred alternative embodiment, the signal detection unit includes a potential-free current measurement or a shunt measurement.

In this variant, the induced voltage is not measured directly. Instead, the induced voltage can be determined indirectly via a potential-free current measurement. For example, the Hall effect can be used here.

Alternatively, a shunt measurement can be performed. For this purpose, the voltage drop across a shunt is measured and the current is calculated therefrom.

A shunt is a resistor, usually of low resistance, connected in series to an electrical circuit or part of an electrical circuit. A current can be measured indirectly by allowing the current to flow across the shunt and measuring the voltage drop across the shunt. The current is then calculated therefrom using Ohm's law. This measurement is called shunt measurement. A shunt can also be a damping resistor at the same time or a shunt and a damping resistor can be designed separately.

In the case of oscillating circuits, it is also possible to measure the voltage drop across the sensor windings or the capacitances.

In a preferred embodiment, the directional deviation value or the averaged directional deviation value or a value derived from the directional deviation value or from the averaged directional deviation value is transferred via a data interface to a bus system, preferably to a CAN bus or to a further computing unit.

As explained above, a directional deviation value is calculated from the ratio of the voltages induced in the sensor windings and allows a determination of a directional deviation angle between the longitudinal direction of the vehicle and the direct connection to the desired defined position. It is therefore possible that the evaluation unit directly passes on the directional deviation value or the averaged directional deviation value, or that further calculation or evaluation steps are carried out beforehand and, for example, a directional deviation angle or other values derived or calculated from the directional deviation value or the averaged directional deviation value are passed on. The corresponding value is passed on via a data interface. A corresponding value generally exhibits a time-dependent curve. The data can be passed on to a bus system. A bus system is a system that is used to enable the transmission of data between the individual participants within a network. The transmission of data is based on special protocols. A protocol commonly used in vehicles is the CAN protocol. “CAN” stands for “Controller Area Network” and a CAN bus is a field bus.

As an alternative to passing on to a bus system, a corresponding value can also be passed on to a further computing unit. The further computing unit may or may not be physically connected to the evaluation unit.

Preferably, the directional deviation value or the averaged directional deviation value or a value derived from the directional deviation value or the averaged directional deviation value is displayed on a direction indicator in the vehicle.

The direction indicator can be shown to the driver, for example, in the form of a pointer on a digital display. Here, the pointer can point directly in the direction in which the driver needs to steer the vehicle, allowing a very intuitive correction of the direction of travel. If the pointer points straight ahead, the driver knows that he is driving his vehicle directly towards the stationary inductive charging device. Alternatively or additionally, the directional deviation value or the averaged directional deviation value can be displayed as a numerical value.

Alternatively, it is possible not to display the directional deviation value or the averaged directional deviation value directly to the driver, but to process it further and use it as part of an algorithm for an automated parking process or for fully automated driving.

In an advantageous embodiment, the mobile inductive charging device and/or the stationary inductive charging device contains at least one flux guiding element and at least one energy transmission winding. The at least one flux guiding element is suitable for guiding a magnetic field during an energy transmission which takes place between an energy transmission winding of the mobile inductive charging device and an energy transmission winding of the stationary inductive charging device. The first sensor winding and the second sensor winding are arranged around at least one of the at least one flux guiding element.

An inductive charging device has an energy transmission winding which can efficiently receive or transmit a magnetic field from or to another energy transmission winding during the charging process. Preferably, powers of 3 kW to 500 kW, preferably 3 kW to 50 kW, can be transmitted here.

An energy transmission winding can be designed in various forms and can consist, for example, of a high-frequency stranded wire with a diameter between 0.5 mm and 10 mm, preferably made of copper.

A flux guiding element is suitable for guiding a magnetic field in a predetermined manner. It has a high magnetic permeability with μᵣ>1, preferably μᵣ>50, particularly preferably μᵣ>100. The flux guiding element is a magnetic core for the energy transmission winding. In particular, the magnetic field is here influenced by the high permeability in such a way that the largest possible magnetic flux is transmitted to the energy transmission winding. With a flux guiding element, the energy transmission winding picks up a larger magnetic flux than without a flux guiding element, with otherwise identical parameters. A flux guiding element can be made of a ferromagnetic or preferably of a ferrimagnetic material, particularly preferably of a ferrite. A flux guiding element can preferably be designed in a plate-like manner—in the form of a planar core—and can be arranged in the inductive charging device on the side of the energy transmission winding which faces away from the further inductive charging device.

Due to the arrangement of the first sensor winding and the second sensor winding around at least one of the at least one flux guiding elements, the at least one of the at least one flux guiding elements assumes a dual function here. It acts as a magnetic core for both the first sensor winding and/or the second sensor winding as well as a magnetic core or flux guiding element for the energy transmission winding. This means that no separate flux guiding element is required for the sensor winding, which leads to simplified manufacturing.

The arrangement of a sensor winding around a flux guiding element here means that at least part of the flux guiding element is enclosed by a sensor winding. The first sensor winding and the second sensor winding can be arranged around the same flux guiding element or around two different flux guiding elements or each can also be arranged around a plurality of flux guiding elements.

The two sensor windings can either be arranged only around one or more flux guiding elements or also around other elements, such as the energy transmission winding and/or a cooling device and/or a shielding device.

Preferably, the first radial longitudinal direction and the second radial longitudinal direction intersect in the region of the area spanned by the energy transmission winding.

The region of the area spanned by the energy transmission winding refers to the area spanned by the energy transmission winding in the plane perpendicular to its winding axis. Thus explicitly also the inner region of the energy transfer winding, in which there is no longer any winding, but not the area which is located outside the energy transmission winding.

The fact that the two radial longitudinal directions of the sensor windings intersect in the area spanned by the energy transmission winding does not necessarily mean that the sensor windings themselves intersect; it is also possible that they would only intersect in the extension.

Arranging the two sensor windings in such a way that the two radial longitudinal directions intersect in the area spanned by the energy transmission winding offers advantages for the evaluation of the two sensor signals.

Particularly preferably, the first radial longitudinal direction and the second radial longitudinal direction intersect at least approximately in the center of the energy transmission winding.

It is particularly preferred that the first radial longitudinal direction and the second radial longitudinal direction intersect at least approximately in the center of the energy transmission winding.

Here, the center of the energy transmission winding refers to the area a few centimeters around the geometric center of the energy transmission winding in the plane perpendicular to the winding axis.

This is advantageous, as the two radial longitudinal directions of the two sensor windings are thus rotated by an angle to the longitudinal direction of the vehicle, which is advantageous for optimal detection of a positional deviation between the vehicle and the stationary inductive charging device.

In addition, the sensor windings are arranged in relation to the energy transmission winding in such a way that the lowest possible voltages are induced in the sensor windings during the energy transmission process.

In a preferred embodiment, the two sensor windings intersect at least approximately in the center of the energy transmission winding. In this embodiment, the sensor windings cover a larger area and more voltage can be induced. In this case, an actual intersecting of the sensor windings takes place, not just an intersecting in the extension of the sensor windings.

It is advantageous if, in this embodiment, the two sensor windings are arranged point-symmetrically to the center of the energy transmission winding.

Preferably, the first radial longitudinal direction and the second radial longitudinal direction are at least approximately parallel to the main direction of the magnetic field lines which form during the energy transmission in the flux guiding element in the region covered by the sensor winding.

The main direction of the magnetic field lines refers to the direction in which the magnetic field lines mainly extend at a given location. The aim here is not to show the exact course of the magnetic field lines through the sensor winding, but rather the radial longitudinal directions should be oriented according to the course of the magnetic field lines in the region of the extension of the sensor winding.

During the energy transmission from the stationary inductive charging device to the mobile inductive charging device, the magnetic field is guided in one or more flux guiding elements. If one or more flux guiding elements are designed in a plate-shaped manner, a magnetic field with magnetic field lines which run approximately radially in relation to the energy transmission winding is established in the flux guiding elements during the charging process. Although a voltage is to be induced in the sensor windings during the positioning process in order to calculate a positional deviation between the vehicle and the stationary inductive charging device therefrom, the magnetic fields are significantly higher during the charging process and it is therefore important that as little voltage as possible is induced in the sensor windings so that these sensor windings or neighboring components are not destroyed. For the induced voltage, the field component perpendicular to the radial longitudinal direction of the sensor windings is relevant. In the case of an arrangement of a sensor winding that ensures that the radial longitudinal direction of the sensor winding is at least approximately parallel to the main direction of the magnetic field lines in the flux guiding elements during the charging process, no or only a small voltage is induced in the sensor winding.

Preferably, the stationary inductive charging device or the mobile inductive charging device has at least two windings, wherein the first winding is an energy transmission winding and the second winding is a positioning signal winding.

During a positioning process, the positioning signal is generated by a positioning signal winding in the stationary inductive charging device or in the mobile inductive charging device. Thus, the energy transmission winding is not used for positioning during a positioning process.

A positioning signal winding can emit a positioning signal during a positioning process. For example, a positioning signal winding can generate a magnetic alternating field with a certain frequency due to an alternating voltage. In principle, an energy transmission winding can also emit a positioning signal, but it is advantageous, as proposed here, to use a separate positioning signal winding to generate a positioning signal. In particular, the positioning signal winding can generate magnetic fields that are more suitable for positioning and, in particular, enable a greater range with the same power. The energy transmission windings are designed to couple as well as possible with the corresponding counterpart. Therefore, they generally do not have a long range in terms of sending or receiving magnetic fields in the longitudinal direction of the vehicle or the target vehicle longitudinal direction. However, this is crucial for a positioning process.

During positioning, the maximum possible power or the maximum possible magnetic fields of the positioning signal are severely limited. They are significantly lower than is the case with an energy transmission process. During the positioning process, there is no vehicle on the stationary inductive charging device. Therefore, it is possible that, for example, a person stands on the stationary inductive charging device. In order for the magnetic fields to remain harmless to a person, they must not exceed flux densities of 27 μT or 6.25 μT, depending on the frequency range.

With a proposed positioning signal winding it is possible to generate positioning signals that comply with the limit values or reference values and still enable a long range.

In a preferred embodiment, the positioning signal winding is designed as a solenoid with a winding axis in the longitudinal direction of the vehicle or the target vehicle longitudinal direction and the stationary inductive charging device or the mobile inductive charging device contains at least one flux guiding element and the flux guiding element is suitable for guiding a magnetic field during an energy transmission process which takes place between a further inductive charging device and the energy transmission winding and the positioning signal winding encloses at least one of the at least one flux guiding elements.

A solenoid is also known as a cylinder coil or solenoid coil. A solenoid can be wound in the form of a helix or a cylindrical spiral. However, the shape of the turn does not have to be circular, but can also have other shapes, such as square-like or rectangle-like or even similar to a rectangle with rounded corners. The important difference to the flat coil is that the turns are not in one plane, but extend along an axis. However, two or more turns can also run parallel and thus be in the same plane perpendicular to the axis.

If the positioning signal winding is located in a mobile inductive charging device of a vehicle, the winding axis of the positioning signal winding is aligned in the longitudinal direction of the vehicle.

If the positioning signal winding is located in a stationary inductive charging device, the winding axis of the positioning signal winding is aligned in the target vehicle longitudinal direction.

In the proposed arrangement, the flux guiding element assumes the guidance of a magnetic field for energy transmission during an energy transmission process and the guidance of a magnetic field for positioning during a positioning process. The flux guiding element here therefore assumes a dual function, which is particularly advantageous as it allows material and installation space to be used efficiently.

The design of the positioning signal winding as a solenoid with a winding axis in the longitudinal direction of the vehicle or in the target vehicle longitudinal direction generates a magnetic field with a main direction of the magnetic field lines in the longitudinal direction of the vehicle or in the target vehicle longitudinal direction. One advantage of this design is that it enables a significantly greater range for positioning than would be the case with a positioning signal generated by an energy transmission winding with the same power or the same magnetic field strength. Furthermore, such an orientation of the magnetic field is also particularly well suited to enable the simplest possible detection of a positional deviation or an angular deviation in the sensor windings.

Particularly preferably, the positioning signal winding is designed such that it has a particularly large extension in the travel plane and perpendicular to the longitudinal direction of the vehicle or to the target vehicle longitudinal direction. For example, the positioning signal winding can extend across the entire width of an inductive charging device. Thus, a largely homogeneous magnetic field is achieved with a main direction of the magnetic flux in the longitudinal direction of the vehicle or the target vehicle longitudinal direction and local field increases are prevented or reduced.

Preferred embodiments of the invention are illustrated in the drawings and are explained in more detail in the following description, wherein identical reference numerals refer to identical or similar or functionally identical components.

### BRIEF DESCRIPTION OF THE DRAWINGS

In the drawings, in each case schematically:

FIG. 1 shows a highly simplified representation of a vehicle with an inductive charging device,

FIG. 2 shows a highly simplified plan view of a vehicle with an inductive charging device that is to be positioned over a stationary inductive charging device that emits a positioning signal,

FIG. 3 shows a highly simplified block diagram showing the signal detection unit and evaluation unit

FIG. 4 shows a block diagram of an evaluation unit

FIG. 5 shows an exemplary embodiment of a signal detection unit

FIG. 6 shows an alternative exemplary embodiment of a signal detection unit

FIG. 7 shows a further alternative exemplary embodiment of a signal detection unit

FIG. 8 shows a further alternative exemplary embodiment of a signal detection unit

FIG. 9 shows a sectional representation of an inductive charging device for a vehicle

FIG. 10 shows a schematic representation of the directions in a winding

FIG. 11 shows a plan view of an inductive charging device with sensor windings

FIG. 12 shows a plan view of an alternative inductive charging device with sensor windings

FIG. 13 shows a plan view of an inductive charging device with positioning signal winding

FIG. 14 shows a schematic representation of a vehicle loading system during the positioning process

### DETAILED DESCRIPTION

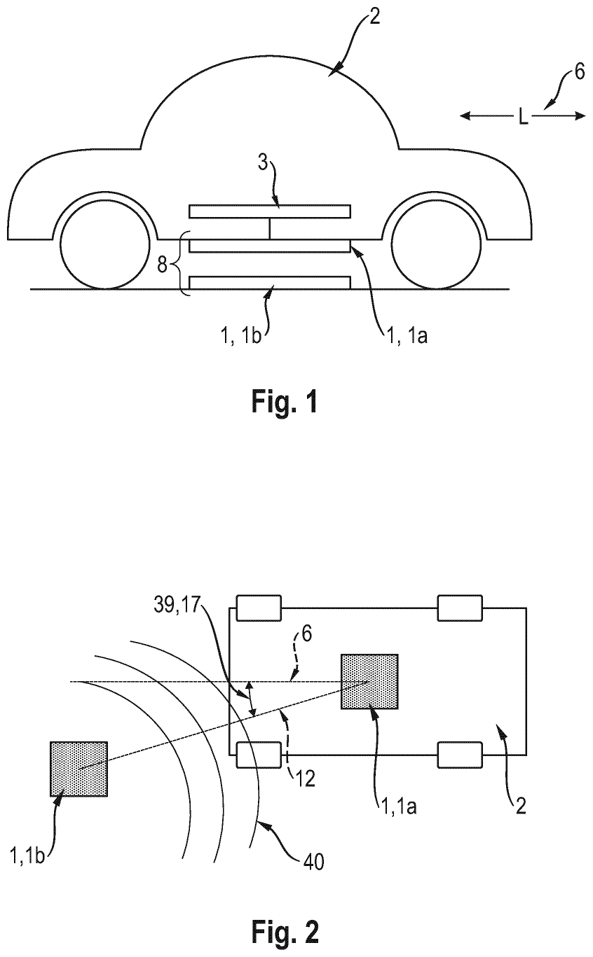

If a part is designated in the figures with reference signs separated by commas, this means that both descriptions apply to the specific designated part. In FIG. 1, for example, 1,1a means: This is an inductive charging device and it is also a mobile inductive charging device.

FIG. 1 shows a mobile inductive charging device 1,1a, which is arranged on a vehicle 2 with a battery 3 and is positioned above a stationary inductive charging device 1,1b. During operation, energy can be transmitted from the stationary inductive charging device 1b to the mobile inductive charging device 1a and the battery 3 can be charged as a result. The mobile inductive charging device 1a and the stationary inductive charging device 1b together form or are part of the vehicle charging system 8. Energy can be temporarily transmitted from the mobile inductive charging device 1a to the stationary inductive charging device 1b.

The stationary inductive charging device 1b arranged on the ground in FIG. 1 can alternatively be recessed into the roadway (not shown here). In a recessed arrangement, the inductive charging device 1b can be covered by certain layers of the roadway or can be flush with the roadway.

FIG. 2 shows a plan view of a vehicle 2 with a mobile inductive charging device 1a, which is to be positioned above a stationary inductive charging device 1b, wherein the longitudinal direction of the vehicle 6 deviates from the direction towards the stationary inductive charging device 1b (connecting line 12 between vehicle 2 and the stationary inductive charging device 1b) by a directional deviation value 17 or a directional deviation angle 39 corresponding thereto.

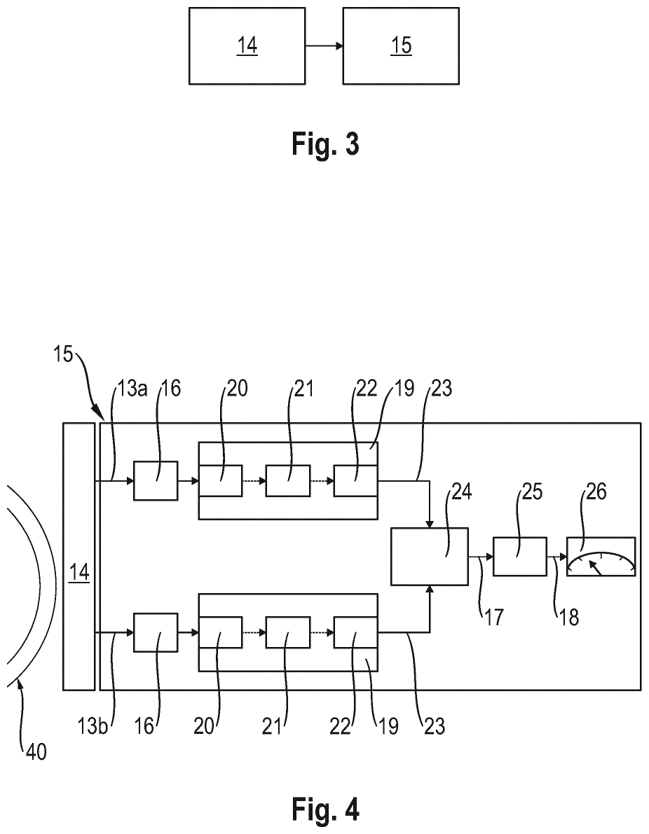

FIG. 3 shows a rough schematic of the detection and evaluation of the sensor signals. The sensor signals, here the voltage signals, are detected in a signal detection unit 14 and evaluated in an evaluation unit 15.

FIG. 4 schematically shows the evaluation unit.

The positioning signal 40 induces a first voltage signal 13a in a first sensor winding 9a (not shown) and a second voltage signal 13b in a second sensor winding 9b (not shown). The two sensor windings 9a, 9b are part of the signal detection unit 14. The intensity of the respective voltage signals and, in particular, the ratio of the two voltage signals in relation to one another provides information about the position, in particular also the angular position, of the vehicle compared to the stationary inductive charging device. Since the two sensor windings are arranged symmetrically to the longitudinal direction of vehicle 6, a directional deviation value 17 can be determined from the two voltage signals 13a and 13b with relatively little effort. The two voltage signals 13a and 13b are each sampled in an analog-to-digital conversion unit 16. The two sampled signals are then each evaluated separately in a computing unit 19. The computing unit 19 initially contains a fast Fourier transform 20. Here, the signals are efficiently transformed into a discrete signal in the frequency domain. A filter 21 then filters out only the frequency domain around the excitation frequency of the positioning signal 40. This efficiently filters out interferences of the signal, thereby achieving significantly greater accuracy and therefore greater range. A maximum determination 22 is then carried out in the filtered frequency band. The two maximum values 23 determined here are compared with one another in a comparison unit 24. For example, a directional deviation value between −1 and 1 can be determined here by subtracting the two maximum values and normalizing to the larger of the two maximum values. Finally, a moving average is determined from a plurality of directional deviation values 17 by an averaging 25. This compensates for fluctuations and thus enables an even greater range. The averaged directional deviation value 18 will now be graphically displayed on an exemplary direction indicator 26.

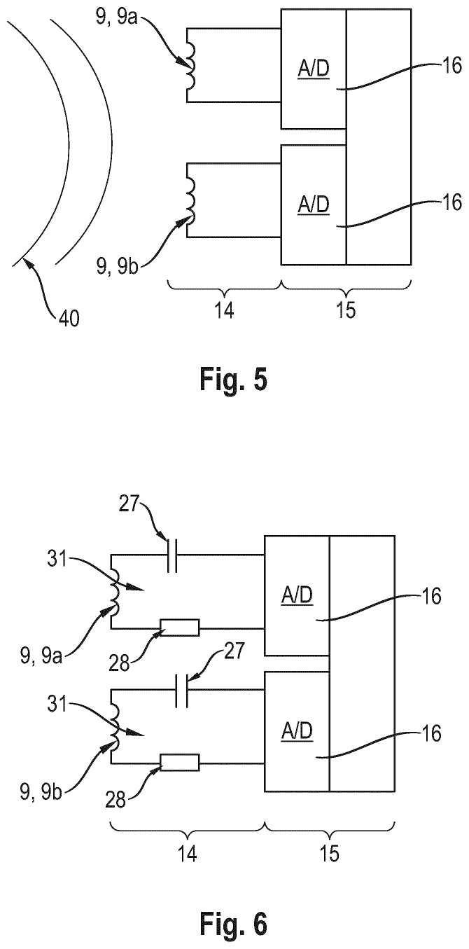

FIG. 5 shows a simple option for a signal detection unit 14 with indicated evaluation unit 15. A positioning signal 40 induces a voltage in the two sensor windings 9a, 9b. Here, the induced voltages at the first sensor winding 9a and at the second sensor winding 9b are measured directly. The first voltage signal 13a and the second voltage signal 13b are then converted into a digital signal in an analog-digital conversion unit 16 and further processed in the further evaluation unit 15.

FIG. 6 shows an alternative embodiment of a signal detection unit 14 with indicated evaluation unit 15. In contrast to the embodiment of FIG. 5, an oscillating circuit 31 is used for signal detection. Here, in each case the oscillating circuit 31 consists of the respective sensor winding 9, a capacitance 27 each and a damping resistor 28 each. The damping resistors 28 can optionally be omitted. The resonance frequency of the oscillating circuit is tuned to the excitation frequency, i.e. the frequency with which the corresponding positioning signal 40 was transmitted.

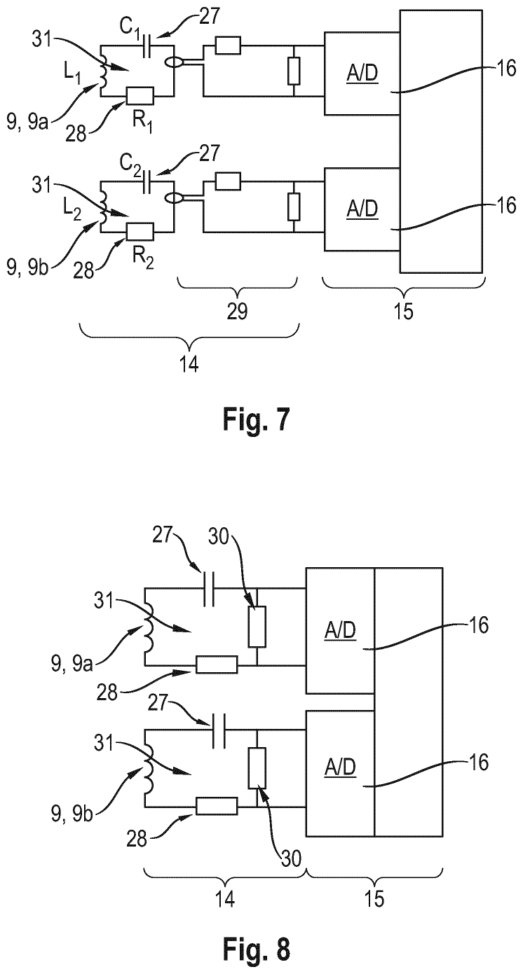

FIG. 7 shows a further alternative embodiment of a signal detection unit 14 with an oscillating circuit 31 and with indicated evaluation unit 15. Here too, the oscillating circuit 31 consists of the respective sensor winding 9, a capacitance 27 each and a damping resistor 28 each. The damping resistors 28 are also optional. The resonance frequency of the oscillating circuit is also tuned to the excitation frequency of the positioning signal 40. In contrast to the exemplary embodiment in FIG. 6, here, however, no voltage measurement is carried out, but the signal is determined via a potential-free current measurement 29.

FIG. 8, in a further exemplary embodiment, also shows an oscillating circuit 31 as in FIG. 7. Here, the current in the respective oscillating circuit 31 is however determined via a shunt 30 by means of a so-called shunt measurement.

In addition to the alternatives shown so far, it is also possible to carry out a direct voltage measurement on the two sensor windings 9 or on the two capacitances 27 (not shown).

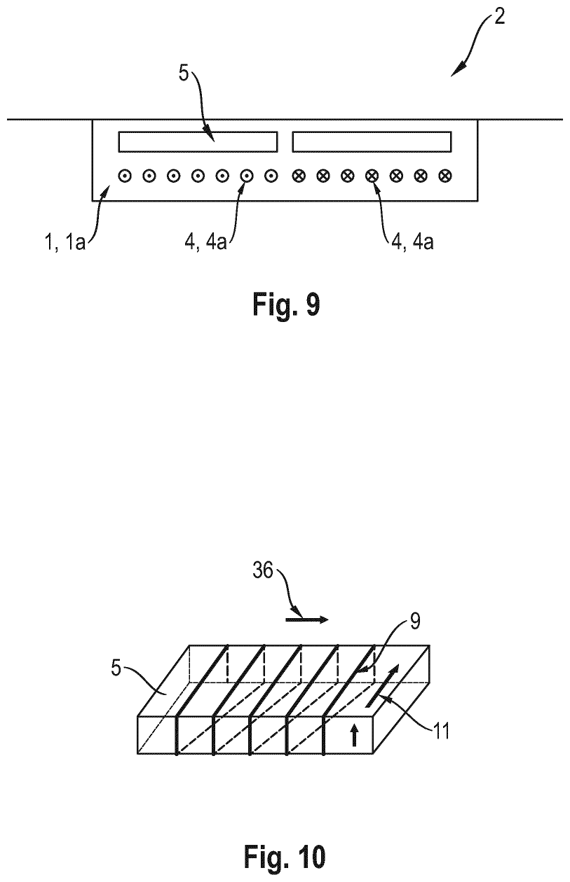

FIG. 9 shows a side section through a mobile inductive charging device 1a, which includes a plurality of flux guiding elements 5 and an energy transmission winding 4,4a and is mounted on a vehicle 2. A corresponding arrangement is also possible with a stationary inductive charging device 1b, except that this device is mounted, for example, on, at or under a floor (not shown).

FIG. 10 schematically shows how the directions, in particular the radial longitudinal direction 11 in a winding, in particular in a sensor winding, are defined here. The example in FIG. 10 is a cylindrical coil with five turns. The direction along which the winding was wound is the winding axis 36. The coil here has a rectangular, not square, cross section. The direction along the longer side of the rectangle is called the radial longitudinal direction 11. If the cross section is not rectangular but elliptical, the radial longitudinal direction 11 runs along the main axis of the ellipse.

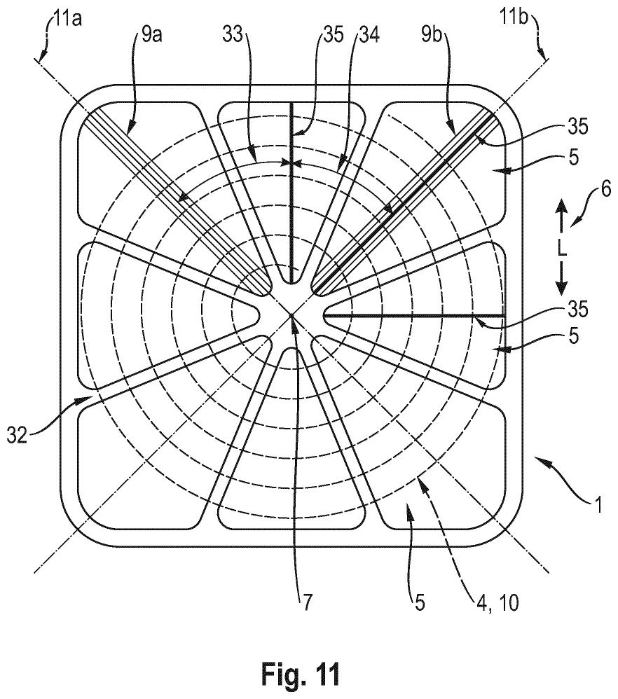

FIG. 11 shows a plan view of an inductive charging device 1 according to the invention. This can be a mobile inductive charging device la or a stationary inductive charging device 1b. In the present exemplary embodiment, eight flux guiding elements 5 are shown, which are arranged radially around the center 7 of the energy transmission winding 4 in the plane. There are narrow gaps 32 between the flux guiding elements 5. The energy transmission winding 4, which is arranged below the flux guiding elements 5 with respect to this plan view, is indicated by dashed lines. The energy transmission winding 4 here is a flat coil 10. A first sensor winding 9a is arranged around one of the flux guiding elements 5 and a second sensor winding 9b is arranged around another flux guiding element 5. Here, the sensor windings are designed as cylindrical coils. The first sensor winding 9a is arranged axially symmetrically to the second sensor winding 9b with respect to the longitudinal direction of the vehicle 6. The first sensor winding 9a has a first radial longitudinal direction 11a and the second sensor winding 9b has a second radial longitudinal direction 11b. The angle 31 between the first radial longitudinal direction 11a and the longitudinal direction of the vehicle 6 is at least approximately equal to the angle 34 between the second radial longitudinal direction 11b and the longitudinal direction of the vehicle. The first radial longitudinal direction 11a and the second radial longitudinal direction 11b intersect or cross one another at least approximately in the center 7 of the energy transmission winding 4. The first radial longitudinal direction 11a and the second radial longitudinal direction 11b run radially outwards from the center 7 of the energy transmission winding 4.

During the charging process, the vehicle 2 is positioned above the stationary inductive charging device 1b and energy is transmitted to the mobile inductive charging device 1a or is transmitted from the mobile inductive charging device 1a to the stationary inductive charging device 1b. The flux guiding elements 5 assume the function of guiding the magnetic field. In flux guiding elements, the field lines of the magnetic field run approximately in a radial direction when in the state of charge. In FIG. 11, three magnetic field lines 35 are symbolically indicated. Since the first radial longitudinal direction 11a and the second radial longitudinal direction 11b here are also aligned radially and thus at least approximately parallel to the magnetic field lines 35, only relatively little or no voltage is induced in the first sensor winding 9a and in the second sensor winding 9b. This is important, as the high power of the energy transmission could otherwise easily lead to the destruction of the sensor windings.

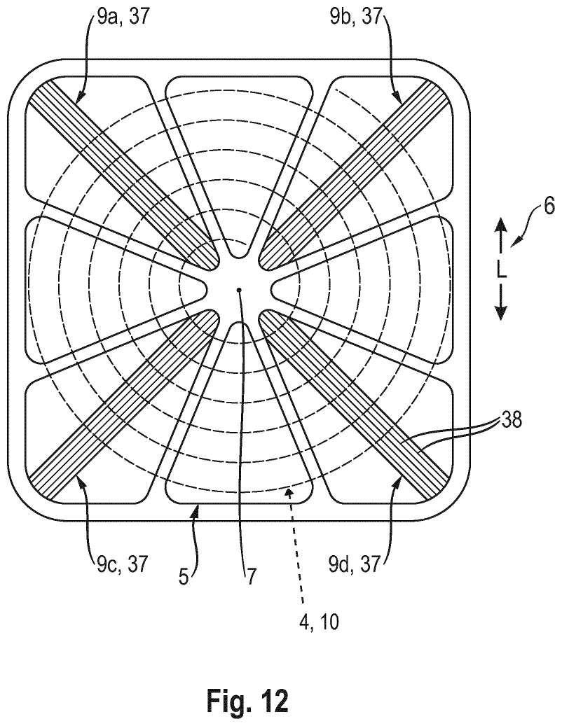

FIG. 12 shows a plan view of a further exemplary embodiment of an inductive charging device 1 according to the invention. Here, there are four sensor windings (a first sensor winding 9a, a second sensor winding 9b, a third sensor winding 9c and a fourth sensor winding 9d). Each sensor winding is arranged around a different one of the eight flux guiding elements 5. Two of the flux guiding elements each are located diagonally opposite one another with respect to the center 7 of the energy transmission coil 4. Together, the four sensor windings 9a, 9b, 9c and 9d form a cross-shaped arrangement. Compared to FIG. 11, here a larger region is covered with sensor windings. At the same time, the region around the center 7 of the energy transmission winding remains free so that mechanically necessary support elements (not shown) can be arranged there. Two of the sensor windings each—for example, in each case the diagonally opposite windings—can be electrically connected, for example in series. Here, the sensor windings are designed in the form of conductor tracks 38 on printed circuit boards 37. Alternatively, the sensor windings can also be designed as stranded wires (not shown).

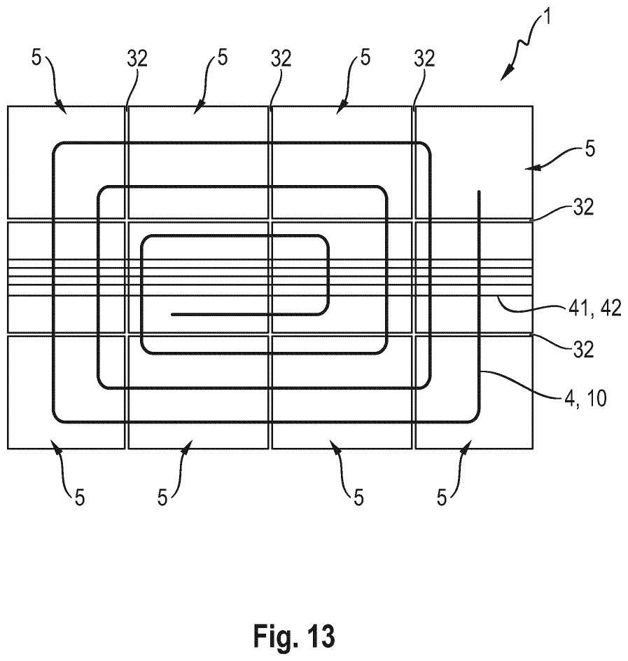

FIG. 13 shows an inductive charging device 1 with an energy transmission winding 4 and a plurality of flux guiding elements 5. The energy transmission winding 4 is designed as a flat coil 10. A positioning signal winding 41 is arranged around the flux guiding elements 5 and around the energy transmission winding 4. The positioning signal winding 41 is designed as a solenoid 42. Here, the positioning signal winding 41 is arranged centrally and running across the center of the energy transmission winding 4.

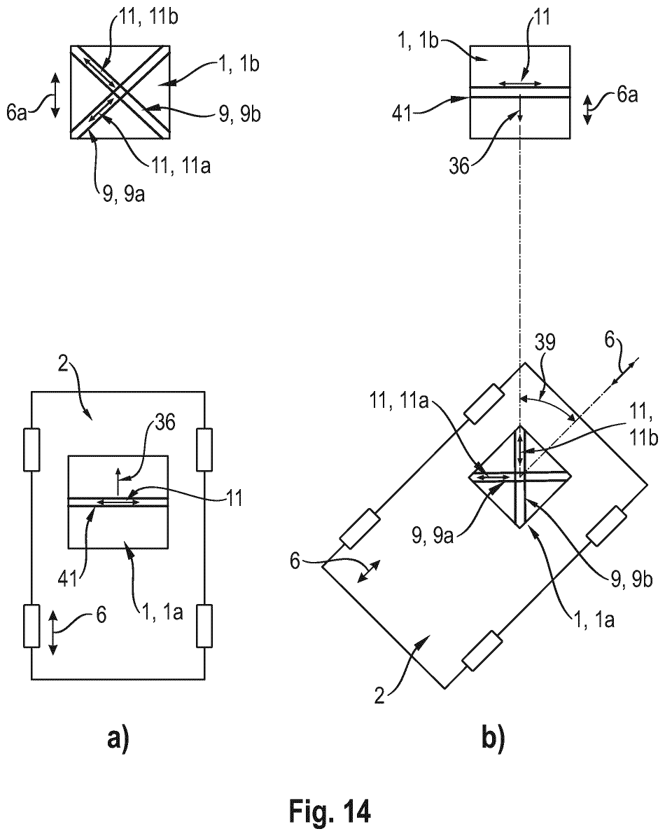

FIG. 14 a) shows a vehicle 2 with a longitudinal direction of the vehicle 6 with a mobile inductive charging device 1a during a positioning process above a stationary inductive charging device 1b with a target vehicle longitudinal direction 6a. The vehicle 2 drives directly towards the stationary inductive charging device 1b and the target vehicle longitudinal direction 6a is thus equal to the longitudinal direction of the vehicle 6. In addition to the energy transmission winding (not shown), the mobile inductive charging device 1a also contains a positioning signal winding 41. The positioning signal winding 41 has a winding axis 36 and a radial longitudinal direction 11. In addition to the energy transmission winding (not shown), the stationary inductive charging device 1b has two sensor windings 9a and 9b. Both sensor windings each have a radial longitudinal direction 11a and 11b. Both sensor windings are arranged symmetrically to the target vehicle longitudinal direction 6a. This arrangement of the windings for positioning is particularly advantageous. The positioning signal winding 41 generates a fairly homogeneous magnetic field. A voltage is induced in the sensor windings 9a and 9b by the magnetic field of the positioning signal winding 41. If the vehicle drives exactly perpendicularly towards the stationary inductive charging device 1b, as shown in the left-hand sketch, an equal voltage is induced in both sensor windings 9a and 9b.

FIG. 14 b) shows an exemplary embodiment in which the positioning signal winding 41 is arranged in the stationary inductive charging device 1b and the sensor windings 9a and 9b are arranged in the mobile inductive charging device 1a. Otherwise, the functionality of this exemplary embodiment is exactly the same. Shown here is a case in which the vehicle 2 does not drive perpendicularly towards the stationary inductive charging device 1b, but deviates therefrom at an angle of approximately 45°. The longitudinal direction of the vehicle 6 and the connecting line between the stationary inductive charging device and the mobile inductive charging device 12 are thus at a directional deviation angle 39 of 45°. In this case, the positioning signal winding 41 generates a magnetic field which is perpendicular to the first sensor winding 9a. Here, a maximum voltage is induced. The magnetic field generated by the positioning signal winding 41 is also approximately parallel to the second sensor winding 9b. Here, a minimum or no voltage is induced.

1. A method for positioning a vehicle having a mobile inductive charging device in a defined position in relation to a stationary inductive charging device, at least one of the mobile inductive charging device and the stationary inductive charging device including a first sensor winding with a first radial longitudinal direction and a second sensor winding with a second radial longitudinal direction, the first radial longitudinal direction and the second radial longitudinal direction arranged at a first angle of 70° to 110° in relation to one another and at a second angle of 35° to 55° in relation to at least one of a longitudinal direction of the vehicle and a target vehicle longitudinal direction, the method comprising:
generating a first voltage signal in the first sensor winding and a second voltage signal in the second sensor winding via a positioning signal;
detecting the first voltage signal in a signal detection unit;
detecting the second voltage signal in the signal detection unit;
converting, via an evaluation unit, the first voltage signal into a first digital signal and the second voltage signal into a second digital signal;
processing and comparing the first digital signal and the second digital signal via the evaluation unit, the processing of the first digital signal and the second digital signal including transforming the first digital signal and the second digital signal into a frequency domain; and
calculating, from the comparison of the first digital signal and the second digital signal, a directional deviation value between the longitudinal direction of the vehicle and a connecting line extending between the stationary inductive charging device and the mobile inductive charging device.

2. The method according to claim 1, further comprising generating the positioning signal in at least one of the stationary inductive charging device and the mobile inductive charging device.

3. The method according to claim 1, wherein the transformation of the first digital signal and the second digital signal into the frequency domain is realized via a discrete Fourier transform.

4. The method according to claim 1, further comprising filtering at least one of the first digital signal and the second digital signal transformed into the frequency domain with a filter having a bandwidth around an excitation frequency of the positioning signal.

5. The method according to claim 1, further comprising determining an averaged directional deviation value via forming an average from a plurality of directional deviation values.

6. The method according to claim 1, wherein:
the first voltage signal is directly a first voltage dropping across the first sensor winding; and
the second voltage signal is directly a second voltage dropping across the second sensor winding.

7. The method according to claim 1, wherein the signal detection unit includes:
a first oscillating circuit including the first sensor winding and a first capacitance; and
a second oscillating circuit including the second sensor winding and a second capacitance.

8. The method according to claim 7, wherein:
the first oscillating circuit further includes a first damping resistor; and
the second oscillating circuit further includes a second damping resistor.

9. The method according to claim 6, wherein the signal detection unit includes at least one of a potential-free current measurement and a shunt measurement.

10. The method according to claim 1, further comprising transferring at least one of the directional deviation value, an averaged directional deviation value, a first value derived from the directional deviation value, and a second value derived from the averaged directional deviation value, via a data interface, to a bus system.

11. The method according to claim 1, further comprising displaying at least one of the directional deviation value, an averaged directional deviation value, a first value derived from the directional deviation value, and a second value derived from the averaged directional deviation value on a direction indicator disposed in the vehicle.

12. The method according to claim 1, wherein:
at least one of the mobile inductive charging device and the stationary inductive charging device includes at least one flux guiding element;
the at least one flux guiding element is configured to guide a magnetic field during an energy transmission between a first energy transmission winding of the mobile inductive charging device and a second energy transmission winding of the stationary inductive charging device; and
the first sensor winding and the second sensor winding are arranged around the at least one flux guiding element.

13. The method according to claim 12, wherein the first radial longitudinal direction and the second radial longitudinal direction intersect in a region of an area spanned by at least one of the first energy transmission winding and the second energy transmission winding.

14. The method according to claim 13, wherein the first radial longitudinal direction and the second radial longitudinal direction intersect at least approximately in at least one of a center of the first energy transmission winding and a center of the second energy transmission winding.

15. The method according to claim 12, wherein the first radial longitudinal direction and the second radial longitudinal direction extend at least approximately parallel to a main direction of a plurality of magnetic field lines present during the energy transmission in the at least one flux guiding element in a region covered by at least one of the first sensor winding and the second sensor winding.

16. The method according to claim 2, wherein:
at least one of the stationary inductive charging device or and the mobile inductive charging device includes at least two windings;
a first winding of the at least two windings is an energy transmission winding; and
a second winding of the at least two windings is a positioning signal winding.

17. The method according to claim 16, wherein:
the positioning signal winding is a solenoid with a winding axis extending in at least one of the longitudinal direction of the vehicle and the target vehicle longitudinal direction;
at least one of the stationary inductive charging device and the mobile inductive charging device includes at least one flux guiding element configured to guide a magnetic field during an energy transmission process between a further inductive charging device and the energy transmission winding; and
the positioning signal winding encloses the at least one flux guiding element.

18. The method according to claim 1, wherein:
the first angle is 90°; and
the second angle is 45°.

19. The method according to claim 3, wherein the discrete Fourier transform is a fast Fourier transform.

20. The method according to claim 5, wherein the plurality of directional deviation values includes at least 10 directional deviation values determined at discrete, successive points in time.
